(19) United States
(12) Patent Application Publication
(10) Pub. No.: US 2020/0410007 A1
(43) Pub. Date: Dec. 31, 2020

(54) SEARCH APPARATUS, SEARCH SYSTEM, AND NON-TRANSITORY COMPUTER READABLE MEDIUM

(71) Applicant: FUJI XEROX CO., LTD., Tokyo (JP)

(72) Inventor: Tadafumi KAWAGUCHI, Kanagawa (JP)

(73) Assignee: FUJI XEROX CO., LTD., Tokyo (JP)

(21) Appl. No.: 16/658,234

(22) Filed: Oct. 21, 2019

(30) Foreign Application Priority Data
Jun. 25, 2019 (JP) 2019-117923

(51) Int. Cl. G06F 16/9032; G06F 17/27; G06F 16/93

(52) U.S. Cl. CPC G06F 16/90324; G06F 3/0482; G06F 16/93; G06F 17/2785

(57) ABSTRACT

A search apparatus includes a receiver and a determining unit. The receiver receives a search term for a search. The determining unit determines suggested terms to be used for refined searches, the refined searches each using the search term and a respective one of the suggested terms. The suggested terms are determined based on (i) an amount of overlap between results of the refined searches and/or (ii) an amount of difference between the number of results of one of the refined searches and the number of results of another one of the refined searches.

### CROSS-REFERENCE TO RELATED APPLICATIONS

This application is based on and claims priority under 35 USC 119 from Japanese Patent Application No. 2019-117923 filed Jun. 25, 2019.

### BACKGROUND

### (i) Technical Field

The present disclosure relates to a search apparatus, a search system, and a non-transitory computer readable medium.

### (ii) Related Art

Japanese Unexamined Patent Application Publication No. 2012-003532 proposes a query suggestion providing apparatus that provides query suggestions by using a search log for storing terms input as queries in association with each other. Specifically, the search log indicating a series of search operations including search queries and re-search queries is referred to, and scores each indicating the degree of association between search queries included in the series of search operations are calculated. At this time, a score between the last query in the series of search operations and a search query other than the last query is given a high weight to calculate the score. When a search query is received from a user terminal, a search query having a high score with the received search query is provided to the user terminal.

Japanese Unexamined Patent Application Publication No. 2008-234559 proposes an information search apparatus for refined searches for documents. Specifically, a morphological analysis is performed for sentences included in documents, terms are extracted and associated with corresponding documents, a reverse index in an initial state is created, a term list in which, for each of the extracted terms, documents including the term are associated is generated, and the term list is displayed on the user terminal. Then, the user is encouraged to select a term from the term list, the reverse index that is reconfigured from a subset of documents that include the selected term is created from the reverse index in the initial state, and the term list is regenerated by using the reconfigured reverse index and redisplayed on the user terminal.

### SUMMARY

In a case where an additional term is input to further narrow pieces of content retrieved by using a certain term, as the method for suggesting terms to be input, a method is available in which a reverse index in which documents that are examples of the pieces of content and terms are associated with each other is used to create and suggest a suggested term list. With the method for suggestion with the suggested term list using the reverse index, in a case where a plurality of terms are suggested for refined searches, pieces of content retrieved by using the terms may overlap or the number of retrieved pieces of content may vary depending on the term used in the search. Therefore, the suggested terms need to be input one by one to find necessary information from among the search results.

Aspects of non-limiting embodiments of the present disclosure relate to providing a search apparatus, a search system, and a non-transitory computer readable medium with which, in a case where an additional term is input to further narrow pieces of content retrieved by using a certain term, it is possible to obtain search results that include more information necessary for the user than with a suggestion method in which a suggested term list is created by using a reverse index.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a search apparatus including a receiver and a determining unit. The receiver receives a search term for a search. The determining unit determines suggested terms to be used for refined searches, the refined searches each using the search term and a respective one of the suggested terms. The suggested terms are determined based on (i) an amount of overlap between results of the refined searches and/or (ii) an amount of difference between the number of results of one of the refined searches and the number of results of another one of the refined searches.

### BRIEF DESCRIPTION OF THE DRAWINGS

Exemplary embodiments of the present disclosure will be described in detail based on the following figures, wherein:

FIG. 1 is a diagram schematically illustrating a configuration of an information processing system according to the exemplary embodiments;

FIG. 2 is a block diagram illustrating an electrical configuration of an information processing terminal and a server in the information processing system according to the exemplary embodiments;

FIG. 3 is a functional block diagram of the server according to a first exemplary embodiment;

FIG. 4 is a diagram illustrating example suggested terms in a case of adding “cooking” to a query;

FIG. 5 is a diagram schematically illustrating a relation between mutual information and “overlap” and indicating that mutual information decreases as “overlap” decreases;

FIG. 6 is a diagram schematically illustrating a relation between mutual information and “imbalance” and indicating that mutual information decreases as “imbalance” decreases;

FIG. 7 is a flowchart illustrating an example flow of a process that is performed in the server according to the first exemplary embodiment;

FIG. 8 is a functional block diagram of the server according to a second exemplary embodiment;

FIG. 9 is a flowchart illustrating an example flow of a process that is performed in the server according to the second exemplary embodiment;

FIG. 10 is a functional block diagram of the server according to a third exemplary embodiment;

FIG. 11 is a diagram illustrating an example of a correspondence table;

FIG. 12 illustrates mutual information calculated on the basis of a correspondence table as scores by using an expression;

FIG. 13 illustrates scores of suggested term lists calculated on the basis of mutual information;

FIG. 14 is a flowchart illustrating an example flow of a process that is performed in the server according to the third exemplary embodiment;

FIG. 15 illustrates candidate suggested terms when “cooking” is added to a query and the numbers of documents that match when the respective terms are added to the query;

FIG. 16 is a diagram illustrating an example in which a “dummy term” is provided;

FIG. 17 is a diagram illustrating an example graphical user interface (GUI) that handles “overlap”, “imbalance”, and “loss”;

FIG. 18 is a diagram for explaining an example in which a term is added to a query by using a GUI handling “overlap”, “imbalance”, and “loss”; and

FIG. 19 is a diagram illustrating an example GUI using a true/false table for terms and documents.

### DETAILED DESCRIPTION

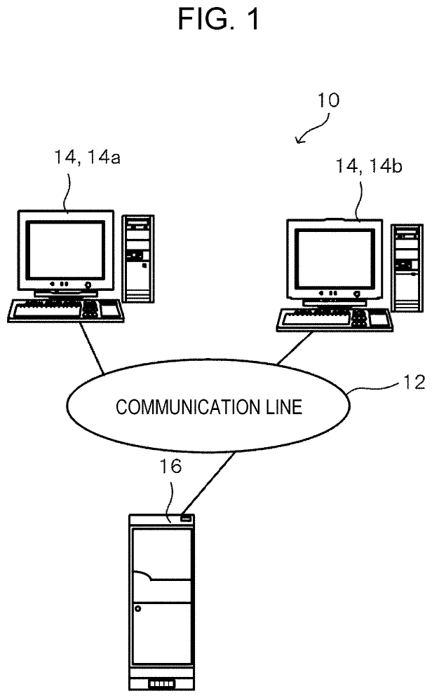

Hereinafter, exemplary embodiments will be described in detail with reference to the drawings. In the exemplary embodiments, an information processing system in which a plurality of information processing terminals and a server are connected to one another via a communication line, which is any type of network, will be described as an example of the search system. FIG. 1 is a diagram schematically illustrating a configuration of an information processing system 10 according to the exemplary embodiments.

The information processing system 10 according to the exemplary embodiments includes a plurality of information processing terminals 14a, 14b, . . . and a server 16, which functions as the search apparatus, as illustrated in FIG. 1. In a case where the information processing terminals 14a, 14b, . . . need not be distinguished from each other in a description, the alphabetical characters at the end of the reference numerals may be omitted. In the exemplary embodiments, the example in which the plurality of information processing terminals 14a, 14b, . . . are included will be described; however, the number of information processing terminals 14 may be one.

The information processing terminals 14 and the server 16 are connected to one another via a communication line 12, which is a local area network (LAN), a wide area network (WAN), the Internet, or an intranet. The information processing terminals 14 and the server 16 are able to transmit and receive various types of data to and from one another via the communication line 12.

In the information processing system 10 according to the exemplary embodiments, the server 16 provides, as a cloud service, a document management service for managing documents. The document management service allows, for example, various documents, which represent information, to be stored on the server 16 and management target documents stored on the server 16 to be browsed when the information processing terminals 14 access the server 16.

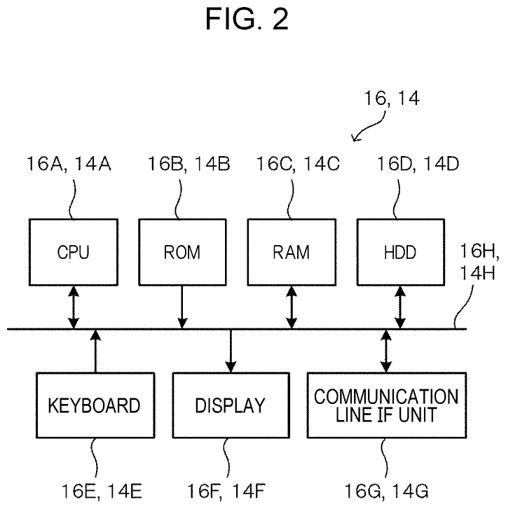

Now, the electrical configuration of the information processing terminal 14 and the server 16 according to the exemplary embodiments will be described. FIG. 2 is a block diagram illustrating the electrical configuration of the information processing terminal 14 and the server 16 in the information processing system 10 according to the exemplary embodiments. The information processing terminal 14 and the server 16 basically have a configuration of a general computer, and therefore, a description is given of the information processing terminal 14 as a representative example.

The information processing terminal 14 according to the exemplary embodiments includes a central processing unit (CPU) 14A, a read-only memory (ROM) 14B, a random access memory (RAM) 14C, a hard disk drive (HDD) 14D, a keyboard 14E, a display 14F, and a communication line interface (IF) unit 14G, as illustrated in FIG. 2. The CPU 14A controls the operations of the information processing terminal 14 as a whole. The ROM 14B stores in advance various control programs, various parameters, and so on. The RAM 14C is used as, for example, a work area when various programs are executed by the CPU 14A. The HDD 14D stores various types of data, application programs, and so on. The keyboard 14E is used to input various types of information. The display 14F is used to display various types of information. The communication line IF unit 14G is connected to the communication line 12 to transmit and receive various types of data to and from other apparatuses connected to the communication line 12. The above-described components of the information processing terminal 14 are electrically connected to one another via a system bus 14H. In the information processing terminal 14 according to the exemplary embodiments, the HDD 14D is used as a storage unit; however, the storage unit is not limited to this, and another nonvolatile storage unit, such as a flash memory, may be used.

With the above-described configuration, in the information processing terminal 14 according to the exemplary embodiments, the CPU 14A performs control so that the ROM 14B, the RAM 14C, and the HDD 14D are accessed, various types of data are obtained via the keyboard 14E, and various types of information are displayed on the display 14F. In the information processing terminal 14, the CPU 14A performs control so that communication data is transmitted and received via the communication line IF unit 14G.

In the information processing system 10 thus configured according to the exemplary embodiments, as described above, the server 16 provides, as a cloud service, the document management service for managing documents. For example, when information stored on the information processing terminal 14 is transferred to the server 16 as a management target document, the document is managed by the server 16, and the document stored on the server 16 is allowed to be accessed by operating the information processing terminal 14.

### First Exemplary Embodiment

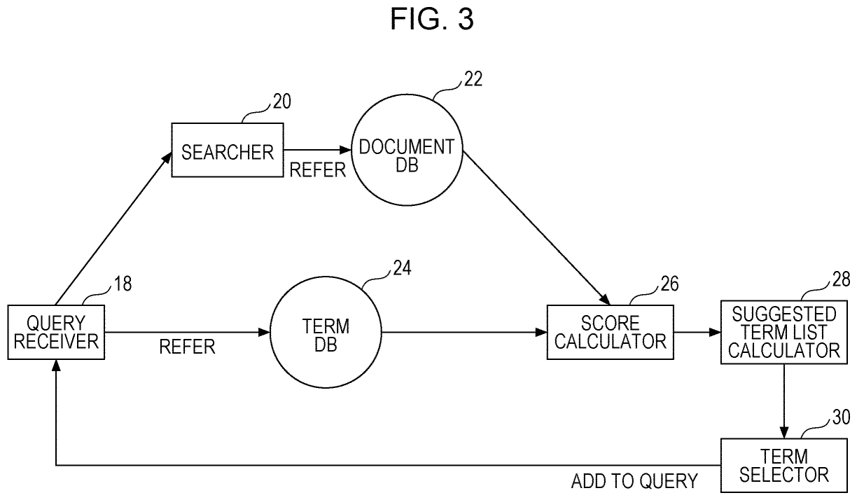

Now, the functional configuration of the server 16 according to a first exemplary embodiment will be described. FIG. 3 is a functional block diagram of the server 16 according to the first exemplary embodiment.

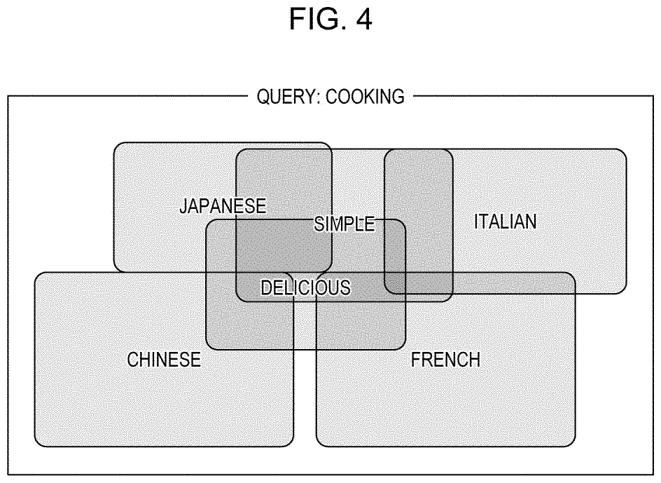

In this exemplary embodiment, a function is provided in which, when document information stored by the document management service provided by the server 16 is searched for from the information processing terminal 14, the server 16 suggests a term list that corresponds to a term input from the information processing terminal 14 to provide assistance in searching. That is, when a character or a character string is input from the information processing terminal 14 as a query, the server 16 suggests, to the information processing terminal 14, a term list corresponding to the character or character string that is being input. For example, as illustrated in FIG. 4, in a case where “cooking” is added to a query, as a list of candidate suggested terms corresponding to “cooking”, “Japanese”, “Italian”, “French”, “Chinese”, “delicious”, and “simple” are suggested. In the following description, a term that is input as a query to search for documents is called a search term, and a term related to a search term input as a query is called a suggested term.

As illustrated in FIG. 3, the server 16 has the functions of a document database (DB) 22, a term DB 24, a query receiver 18, which functions as a receiver, a searcher 20, a score calculator 26, a suggested term list calculator 28, which functions as a determining unit, and a term selector 30.

The document DB 22 stores therein document information registered in advance on the server 16 and allows documents to be registered and browsed from the information processing terminal 14.

When a document is registered in the document DB 22, the term DB 24 registers therein terms extracted from the document in association with the document.

In a case where the user operates the information processing terminal 14 to input a term used to search for documents, the query receiver 18 obtains and receives, from the information processing terminal 14, the input term as a search term. The query receiver 18 refers to the term DB 24, searches for the received term, and outputs the result of search to the score calculator 26.

The searcher 20 refers to the term received by the query receiver 18, and creates and outputs, to the score calculator 26, a list of search target documents that match a condition. That is, the searcher 20 searches the document DB 22 for documents that include the term received by the query receiver 18, and outputs a list of the retrieved documents to the score calculator 26.

The score calculator 26 calculates scores each indicating a relation between terms by using correspondences between the document DB 22 and the term DB 24.

The suggested term list calculator 28 calculates an optimized number of terms for which the score calculated by the score calculator 26 is lowest as a suggested term list. In this exemplary embodiment, in a case of outputting a plurality of suggested terms for narrowing search results obtained by using the search term received by the query receiver 18, the suggested term list calculator 28 determines an optimized number of suggested terms for which at least one of “overlap” and “imbalance” is smaller than in a case of narrowing with a combination of the other terms.

The term selector 30 adds a term selected by the user from the suggested term list calculated by the suggested term list calculator 28 to the query as a search term.

Now, score calculation by the score calculator 26 and suggested term list calculation by the suggested term list calculator 28 will be described in detail.

In this exemplary embodiment, refined searches are conducted by using not a term but a suggested term list. That is, relations between suggested terms are taken into consideration. In this exemplary embodiment, scoring is performed for “overlap”, “imbalance”, and “loss” of search results in a case where a suggested term list is added to a query. Note that “overlap” refers to a state where, when terms are added to a query, respective refined search results overlap, “imbalance” refers to a state where, when terms are added to a query, the respective numbers of narrowed documents are different from each other, and “loss” refers to a state where, even when any term in the suggested term list is added to a query, no documents match in the search.

As the method for scoring of “overlap”, for example, a method of using a similarity score between sets, such as the Jaccard coefficient, the Dice coefficient, or the Simpson coefficient, is available. Specifically, when a set of documents that match in a search when a term wᵢ is added is represented by rᵢ, and a set of documents that match in a search when a term wⱼ is added is represented by rⱼ, the Jaccard coefficient Jᵢⱼ is expressed by the following expression (1).

$${J}_{ij} = \frac{\vert {r}_{i} ⋂ {r}_{j} \vert}{\vert {r}_{i} ⋃ {r}_{j} \vert} \qquad ( 1 )$$

That is, the suggested term list calculator 28 needs to select a list of terms for which the sum J of the Jaccard coefficients for the suggested term list is smallest. The sum J of the Jaccard coefficients is expressed by the following expression (2).

$$J = {\sum }_{i} {\sum }_{j \neq i} {J}_{ij} \qquad ( 2 )$$

As the method for scoring of “imbalance”, for example, a method of using a difference in the number of documents obtained by adding suggested terms to a query is available. Specifically, when the number of documents that match in a search when the term wᵢ is added is represented by rᵢ, and the number of documents that match in a search when the term wⱼ is added is represented by rⱼ, the score Dᵢⱼ of “imbalance” is expressed by the following expression (3) by using the difference.

$${D}_{ij} = \frac{\vert {r}_{i} - {r}_{j} \vert}{\vert {r}_{i} \vert + \vert {r}_{j} \vert} \qquad ( 3 )$$

That is, the suggested term list calculator 28 needs to select a list of terms for which the sum D of the absolute values of the differences for the suggested term list is smallest. The sum D is expressed by the following expression (4).

$$D = {\sum }_{i} {\sum }_{j \neq i} {D}_{ij} \qquad ( 4 )$$

As the method for simultaneous scoring of “overlap” and “imbalance”, for example, a method of using mutual information between the probability that terms in the suggested term list are selected and the probability of the refined search type (AND search or NOT search) is available. When the number of documents that match in a search when the term wᵢ is added is represented by rᵢ, the number of documents that match in a search when the term wⱼ is added is represented by rⱼ, and the union of rᵢ and rⱼ is represented by rᵢⱼ, mutual information Iᵢⱼ is obtained from the difference between the entropy H(p(rᵢⱼ)) of the portability p(rᵢⱼ) that a certain document is selected from the union rᵢⱼ and the entropy H(p(rᵢⱼ|t)) of the probability p(rᵢⱼ) based on the probability p(t) of the refined search type.

$$\begin{matrix}{I}_{ij} = H ( p ( {r}_{ij} ) ) - H ( p ( {r}_{ij} \vert t ) ) & ( 5 ) \\ = log ( \frac{{r}_{ij}}{\sqrt{{r}_{i} ( {r}_{ij} - {r}_{i} )}} ) & ( 6 )\end{matrix}$$

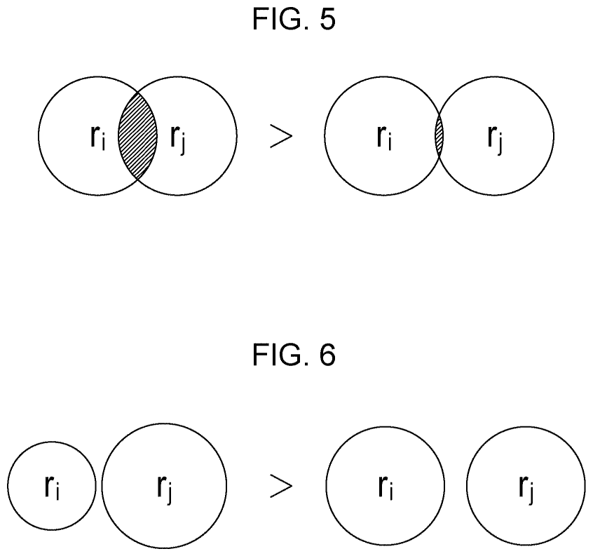

FIG. 5 and FIG. 6 schematically illustrate a relation between mutual information and “overlap” and a relation between mutual information and “imbalance” respectively. As “overlap” decreases, mutual information decreases. As “imbalance” decreases, mutual information decreases. The mutual information Iᵢᵢ corresponds to “overlap” and “imbalance” between a “refined search using the term wᵢ” and a “refined search using the term wⱼ”. That is, the suggested term list calculator 28 needs to select a list of terms for which the sum I of mutual information of the suggested term list is smallest. The sum I of mutual information is expressed by the following expression (7).

$$I = {\sum }_{i} {\sum }_{j \neq i} {I}_{ij} \qquad ( 7 )$$

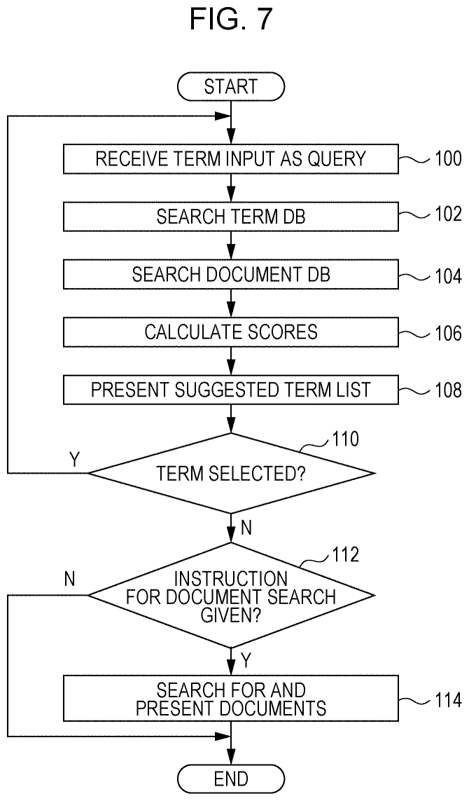

Now, a specific process that is performed in the server 16 according to this exemplary embodiment will be described. FIG. 7 is a flowchart illustrating an example flow of the process that is performed in the server 16 according to this exemplary embodiment. The process in FIG. 7 starts in a case where the information processing terminal 14 is operated by the user and a term is input as a query.

In step 100, the query receiver 18 receives a term input from the information processing terminal 14 as a query, and the flow proceeds to step 102.

In step 102, the query receiver 18 refers to the term DB 24 and searches for the received term, and the flow proceeds to step 104.

In step 104, the searcher 20 searches the document DB 22 for documents that include the term received by the query receiver 18, and the flow proceeds to step 106.

In step 106, the score calculator 26 calculates scores each indicating a relation between terms by using correspondences between the document DB 22 and the term DB 24, and the flow proceeds to step 108. To calculate the scores, as described above, the method for scoring of “overlap” may be used, the method for scoring of “imbalance” may be used, or the method for simultaneous scoring of “overlap” and “imbalance” may be used.

In step 108, the suggested term list calculator 28 calculates an optimized number of terms for which the score calculated by the score calculator 26 is smallest as the suggested term list and presents the suggested term list to the user, and the flow proceeds to step 110.

In step 110, the term selector 30 determines whether an instruction is given for adding, to the query as a search term, a term selected by the user from the suggested term list calculated by the suggested term list calculator 28. In a case where the result of determination is positive, the term selector 30 adds the specified term to the query, the flow returns to step 100, and the above-described process is repeated. In a case where the result of determination is negative, the flow proceeds to step 112.

In step 112, the term selector 30 determines whether an instruction for searching for documents is given without selection of a term. In a case where the result of determination is positive, the flow proceeds to step 114. On the other hand, in a case where the term input as the query is reset and another term is input as a query or in a case where an instruction for another process is given, the result of determination is negative, and the process ends.

In step 114, the CPU 16A searches the document DB 22 for documents that include the terms input as the query and presents the documents on the information processing terminal 14, and the process ends.

### Second Exemplary Embodiment

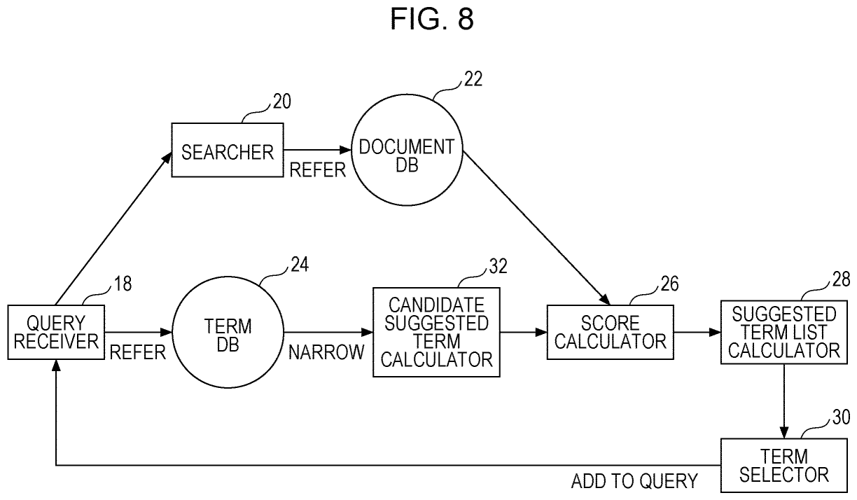

Now, the functional configuration of the server 16 according to a second exemplary embodiment will be described. FIG. 8 is a functional block diagram of the server 16 according to this exemplary embodiment. Note that configurations the same as those in the above-described exemplary embodiment are given the same reference numerals, and detailed descriptions thereof will be omitted.

In the above-described exemplary embodiment, when the score calculator 26 calculates scores, the issue of computational load arises. For example, in a case where the number of terms registered in the term DB 24 is W, and N terms are selected from among the W terms as the suggested term list, the number of combinations of terms is _{w}C_{N}, and the calculation might not be possible within a practical time in a case where the number of terms is large.

In this exemplary embodiment, as illustrated in FIG. 8, the function of a candidate suggested term calculator 32, which functions as a limiter, is further provided to limit, on the basis of the input query, the number of candidate suggested terms in the term DB 24 to be used in calculation of scores.

As the technique for limiting candidate suggested terms, for example, nearby terms in a word embedding space, such as word2vec (Mikolov, T., Chen, K., Corrado, G., & Dean, J. (2013), Efficient estimation of word representations in vector space, arXiv preprint arXiv: 1301.3781.) or fastText (Joulin, A., Grave, E., Bojanowski, P., & Mikolov, T. (2016), Bag of tricks for efficient text classification, arXiv preprint arXiv: 1607.01759), may be used. Alternatively, nearby terms on the Knowledge Graph (ontology) may be used.

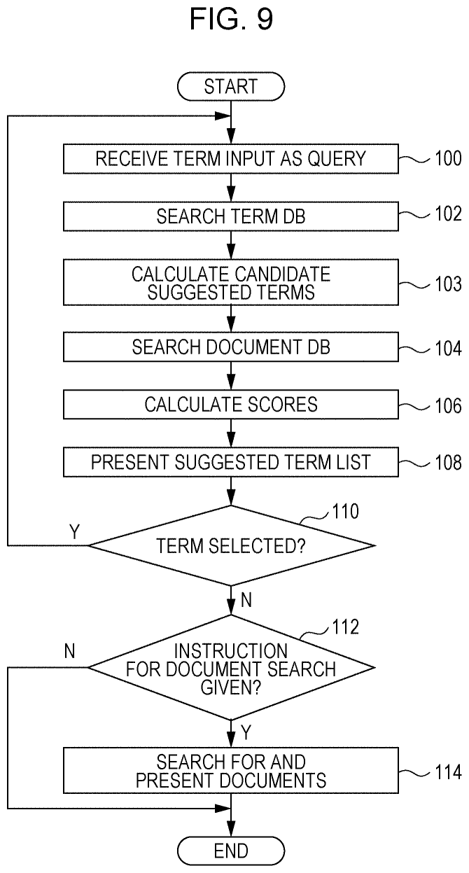

FIG. 9 is a flowchart illustrating an example flow of a process that is performed in the server 16 according to this exemplary embodiment. Note that steps the same as those in FIG. 7 are assigned the same reference numerals, and detailed descriptions thereof will be omitted.

As illustrated in FIG. 9, step 103 is added to FIG. 7. In step 103, the candidate suggested term calculator 32 calculates candidate suggested terms. Therefore, scores are calculated for limited terms to thereby reduce the computational load and quickly suggest a term list to the user.

### Third Exemplary Embodiment

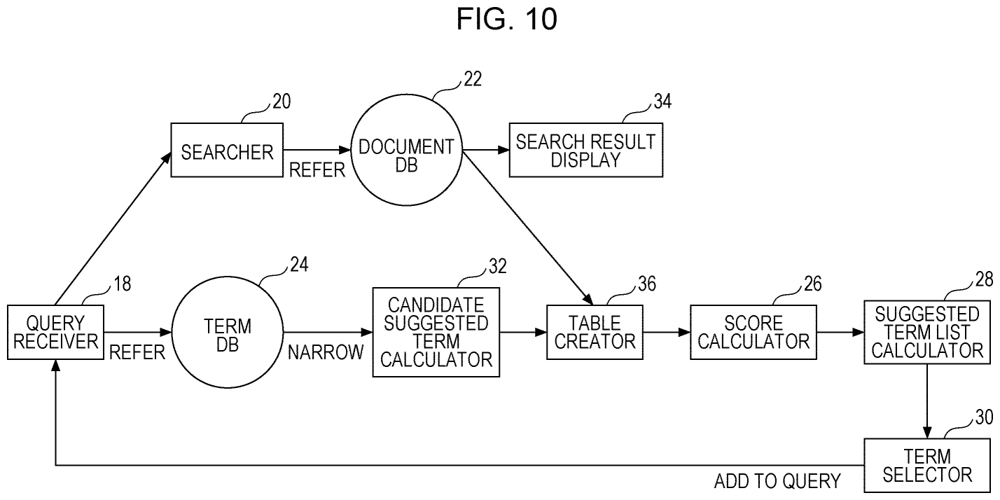

Now, the functional configuration of the server 16 according to a third exemplary embodiment will be described. FIG. 10 is a functional block diagram of the server 16 according to this exemplary embodiment. Note that configurations the same as those in the above-described exemplary embodiments are given the same reference numerals, and detailed descriptions thereof will be omitted.

The server 16 according to this exemplary embodiment further has the functions of a search result display 34 and a table creator 36 in addition to the functions in the second exemplary embodiment.

The search result display 34 performs a process for displaying the results of searching the document DB 22 by the searcher 20 on the information processing terminal 14 operated by the user.

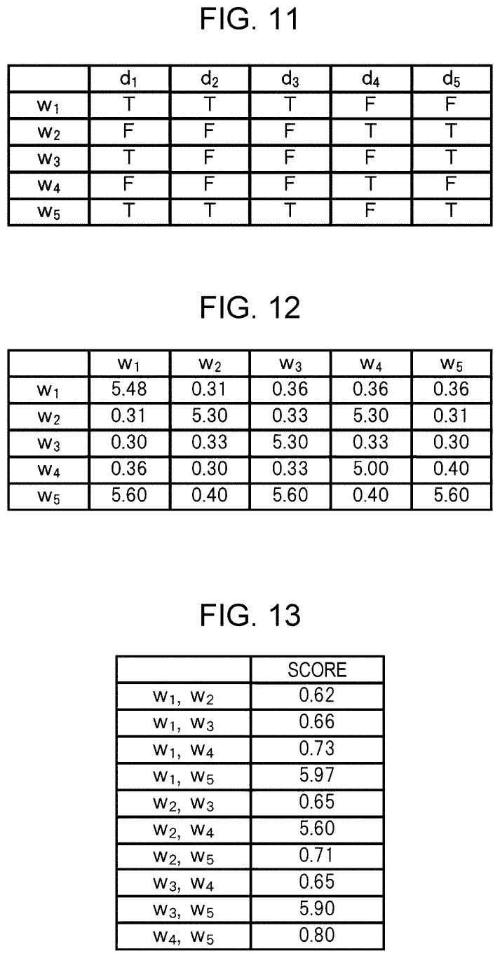

The table creator 36 creates a correspondence table indicating correspondences between the candidate suggested terms calculated by the candidate suggested term calculator 32 and the documents retrieved by the searcher 20. FIG. 11 is a diagram illustrating an example of the correspondence table.

In the example illustrated in FIG. 11, registered terms W in the term DB 24 and registered documents D in the document DB 22 are defined as follows for simplification.

W={w₁,w₂,w₃,w₄,w₅}, D={d₁,d₂,d₃,d₄,d₅} (8)

On the basis of the defined registered terms and target documents, the score calculator 26 calculates scores and the suggested term list calculator 28 calculates the suggested term list.

In FIG. 11, “T” indicates that the word w corresponds to the document d, that is, the document d matches in the search, and “F” indicates that the word w does not correspond to the document d, that is, the document d does not match in the search.

FIG. 12 illustrates the results of calculating mutual information as scores on the basis of the correspondence table illustrated in FIG. 11 by using the following expression (9).

$${I}_{ij} = log ( \frac{{r}_{ij}}{\sqrt{{r}_{i} ( {r}_{ij} - {r}_{i} ) + Δ r}} ) \qquad ( 9 )$$

Here, Δr represents a very small amount and is provided in order to prevent a situation where calculation is not possible in a case where rⱼ is a subset of rᵢ, rᵢⱼ−rᵢ=0 holds, and division by 0 is to be done. Here, Δr=1.0×10⁻⁵ is assumed, and calculation is performed. Mutual information is asymmetric, and therefore, the scores of the same combinations differ when the reference differs (for example, the score of w₁, w₃ is different from that of w₃, w₁).

FIG. 13 illustrates the results of calculation of scores of suggested term lists (in the example illustrated in FIG. 13, each list includes two terms) on the basis of the results illustrated in FIG. 12. In the example illustrated in FIG. 13, the score of w₁, w₂ is smallest, and this suggested term list is selected. With reference to w₁, w₂ in FIG. 11, the list is small in “overlap” and “imbalance” for “T”. For example, the pair of w₄, w₅ is a pair that has “imbalance” but has no “overlap”, and mutual information is 0.80, which is larger than other pairs. The pair of w₂, w₃ is a pair that has “overlap” but has no “imbalance”, and mutual information is larger than that of the pair of w₁, w₂. Also from these results, it is found that, with mutual information, scoring of “overlap” and “imbalance” is simultaneously performed.

In the example presented here, the number of registered terms is five, and the number of combinations of two selected terms is ten (₅C₂=10); however, as the number of registered terms and the number of selected terms increase, the number of combinations when the suggested term list is created increases. Therefore, filtering needs to be performed to, for example, limit the number of registered terms to be used in list calculation.

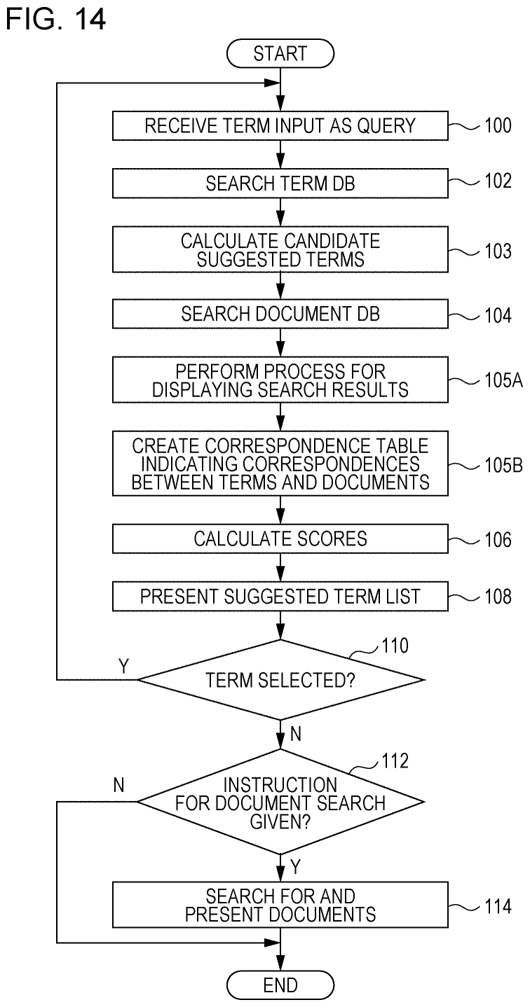

FIG. 14 is a flowchart illustrating an example flow of a process that is performed in the server 16 according to this exemplary embodiment. Note that steps the same as those in FIG. 9 are assigned the same reference numerals, and detailed descriptions thereof will be omitted.

In this exemplary embodiment, as illustrated in FIG. 14, in step 104, the searcher 20 searches the document DB 22 for documents that include the term received by the query receiver 18, and thereafter, the flow proceeds to step 105A.

In step 105A, the search result display 34 performs a process for displaying the results of searching by the searcher 20 on the information processing terminal 14 operated by the user, and the flow proceeds to step 105B.

In step 105B, the table creator 36 creates the correspondence table indicating correspondences between the candidate suggested terms calculated by the candidate suggested term calculator 32 and the documents retrieved by the searcher 20. Thereafter, the flow proceeds to step 106 described above, and the score calculator 26 calculates scores each indicating a relation between terms by using the created correspondence table.

In the above-described exemplary embodiments, the score calculator 26 is able to perform calculations of “overlap”, “imbalance”, and “loss” separately. For example, with mutual information, it is possible to quantify “overlap” and “imbalance”, but it is not possible to quantify “loss”. Therefore, scoring of “loss” is performed first, and mutual information is calculated on the basis of data of the scoring to thereby take into consideration “overlap”, “imbalance”, and “loss”. Accordingly, “overlap”, “imbalance”, and “loss” are expressed by various calculations, and the method for scoring may be changed in accordance with the target. Further, when a threshold is set in each calculation step, this may be used as filtering for reducing the computational load. Specifically, with mutual information, it is not possible to quantify “loss”. To suppress “loss”, a lower limit (hereinafter referred to as the “necessary number of documents”) is set on the number of documents that are to match when a term is added to a query to set a limit on the number of documents, and terms are filtered. From the number of suggested terms Wₙ and the number of documents D, the necessary number of documents Dₙ is determined. The score calculator 26 selects terms that satisfy the condition from the table when calculating scores, and calculates mutual information to thereby handle “loss”. In this case, the score calculator 26 functions as a restrictor.

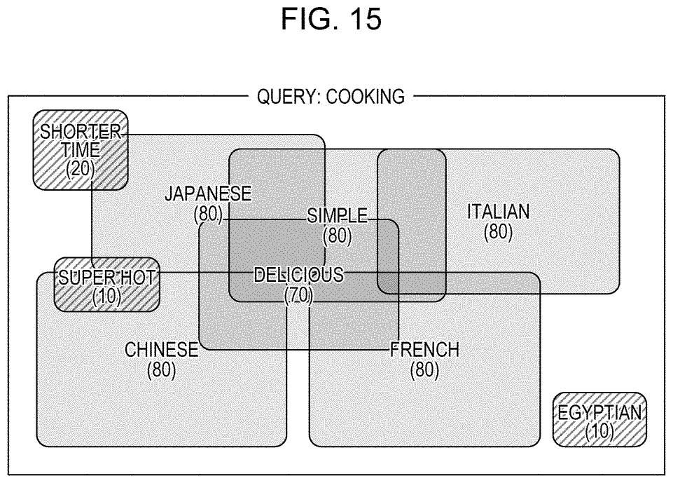

An example in which a lower limit is set on the number of documents for filtering is specifically described. FIG. 15 illustrates candidate suggested terms when “cooking” is added to a query and the numbers of documents that match when the respective terms are added to the query. It is assumed that the number of documents R that match in the case where “cooking” is added to a query is equal to 200, and the number of suggested terms Wₙ is equal to 5. The necessary number of documents Dₙ is defined by the following expression (10). It is assumed that the necessary number of documents Dₙ is the number of hits per term for zeroing “loss” when “overlap” is assumed to be zero.

Dₙ=R/Wₙ (10)

In a case where the number of documents R is equal to 200 and the number of suggested term Wₙ is equal to 5, the necessary number of documents Dₙ is equal to 40. In the example illustrated in FIG. 15, “shorter time”, “Egyptian”, and “super hot” are excluded from calculation of mutual information.

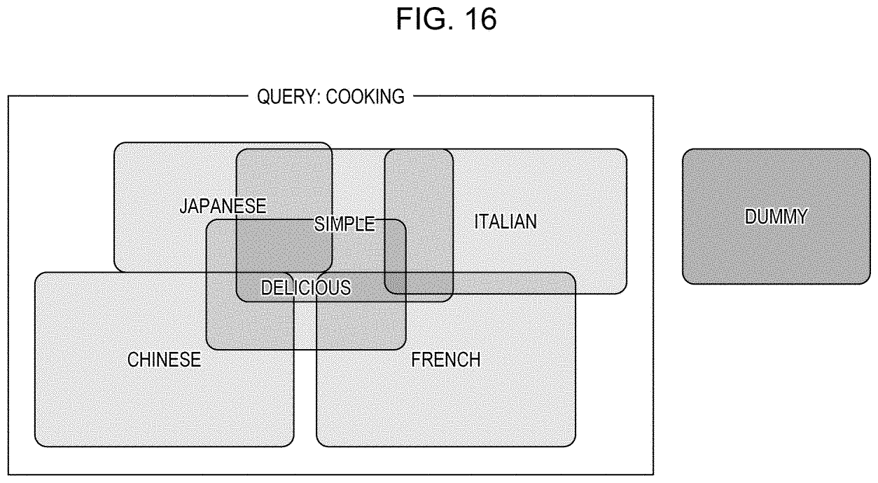

In the above-described exemplary embodiments, in a case where the score calculator 26 performs scoring by using mutual information, a “dummy term” may be used to suppress “loss”. With mutual information, it is not possible to quantify “loss”. Therefore, a “term with which the search result includes an ideal number of documents and the search result does not overlap with search results using the other terms” is provided as a “dummy term” as illustrated in FIG. 16. The “dummy term” has no “overlap” with the other terms, and therefore, mutual information is calculated only with “imbalance”. That is, when a “dummy term” is used, “loss” is suppressed.

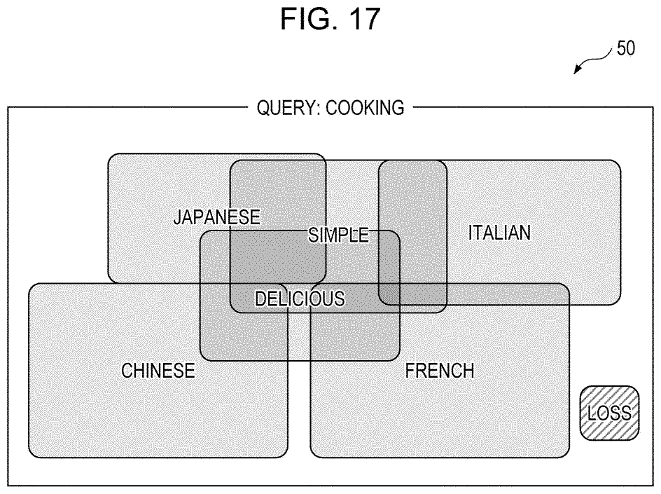

In the above-described exemplary embodiments, the server 16 may provide a GUI that handles “overlap”, “imbalance”, and “loss”. That is, “overlap”, “imbalance”, and “loss” in a case of addition to a query from the suggested term list may be explicitly displayed. Specifically, when the suggested term list calculator 28 calculates and presents, to the user, the suggested term list in step 108 described above, a screen 50 as illustrated in FIG. 17 may be presented to the user as a GUI. In this case, the suggested term list calculator 28 functions as a display unit.

In FIG. 17, the number of documents for a query (“cooking”) before a refined search is represented by the outermost rectangular region, and the amount of documents in a case where a term in the suggested term list is added to the query is represented by a region in which the term is written. Further, “overlap” in a case where a term in the suggested term list is added to the query is represented by the size of the overlapping portion of the corresponding regions, “imbalance” in the case where a term in the suggested term list is added to the query is represented by the difference between the corresponding regions, and “loss” in the case where a term in the suggested term list is added to the query is represented by the size of a portion in which no regions exist or is explicitly indicated as the region of “loss”.

When “overlap”, “imbalance”, and “loss” are explicitly displayed, the user is allowed to visually check relations between terms directly, which facilitates understanding. Further, the extent to which the documents are narrowed by selecting a term is easily checked, which increases efficiency.

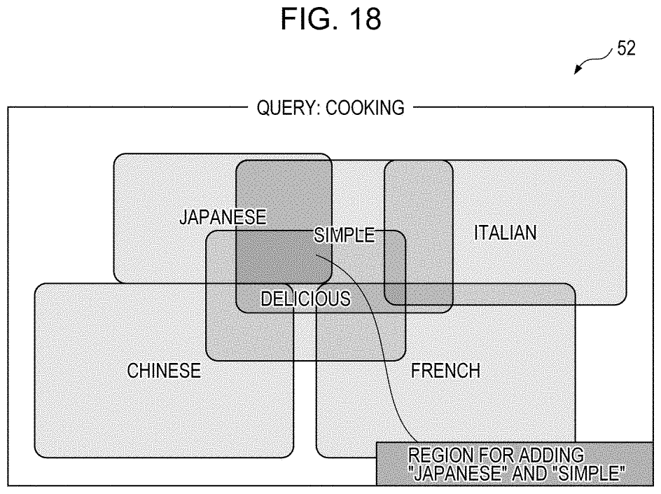

In the above-described exemplary embodiments, a GUI that handles “overlap”, “imbalance”, and “loss” may be used to add a term to a query. For example, the suggested term list calculator 28 may provide a GUI with which, when the user operates the information processing terminal 14 to perform an operation of specifying a region on a screen 52 illustrated in FIG. 18, a term corresponding to the specified region is added to the query. For example, in a case where the user performs an operation of specifying an overlapping region on the screen 52 illustrated in FIG. 18, a plurality of terms that form “overlap” are added to the query at once. When addition of a term by using the GUI is made possible, the user is allowed to select a query while checking relations between terms, which results in an efficient refined search. In this case, the suggested term list calculator 28 functions as an adding unit.

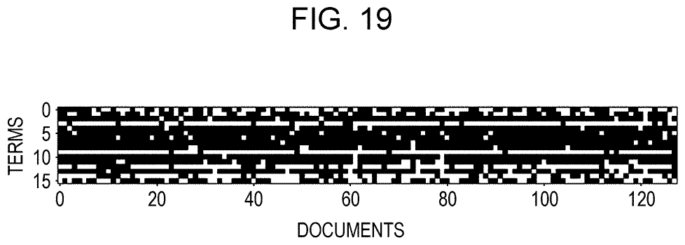

As the GUI, a GUI using a true/false table for terms and documents may be applied. Specifically, a GUI using a truth value table in which the vertical axis represents terms and the horizontal axis represents documents, as illustrated in FIG. 19, is applied. A case where a term and a document match is assumed to be “true”, and the cell is filled and represented in “white”. A case where a term and a document do not match is assumed to be “false”, and the cell is not filled and represented in “black”. When such a true/false table is created, correspondences between terms and documents are explicitly expressed.

Further, when a technique such as an Infinite Relation Model (IRM) (Charles, K., Joshua, T., Thomas, G., Takeshi, Y., & Naonori, U. (2006), Learning Systems of Concepts with an Infinite Relational Model, AAAI) is used, clustering of the table is made possible, which facilitates understanding of relations between terms and relations between documents.

The processes that are performed in the server 16 according to the above-described exemplary embodiments may be processes that are performed by using software, processes that are performed by using hardware, or processes that are performed by using a combination of software and hardware. The processes that are performed in the server 16 may be stored in a storage medium as a program and distributed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A search apparatus comprising:
a receiver that receives a search term for a search; and
a determining unit that determines suggested terms to be used for refined searches, the refined searches each using the search term and a respective one of the suggested terms, wherein
the suggested terms are determined based on (i) an amount of overlap between results of the refined searches and/or (ii) an amount of difference between the number of results of one of the refined searches and the number of results of another one of the refined searches.

2. The search apparatus according to claim 1, wherein
the determining unit obtains relations between terms by using correspondences between a document list obtained by extracting documents that include the search term received by the receiver from among documents stored in advance and terms stored in advance, and determines the suggested terms from the obtained relations between terms.

3. The search apparatus according to claim 2, wherein
the determining unit obtains, as the relations between terms, mutual information between a probability that terms to be suggested are selected and a probability of a refined search type, and determines the suggested terms so that the mutual information is smallest or is equal to or smaller than a predetermined threshold.

4. The search apparatus according to claim 2, further comprising
a limiter that limits, by using the search term received by the receiver, the number of terms to be used to obtain the relations between terms.

5. The search apparatus according to claim 3, further comprising
a limiter that limits, by using the search term received by the receiver, the number of terms to be used to obtain the relations between terms.

6. The search apparatus according to claim 2, further comprising
a restrictor that sets a restriction on a necessary number of documents for the document list, wherein
the determining unit obtains the relations between terms by using correspondences between the document list obtained by extracting documents that include the search term received by the receiver from among documents that match the restriction set by the restrictor and the terms stored in advance, and determines the suggested terms.

7. The search apparatus according to claim 3, further comprising
a restrictor that sets a restriction on a necessary number of documents for the document list, wherein
the determining unit obtains the relations between terms by using correspondences between the document list obtained by extracting documents that include the search term received by the receiver from among documents that match the restriction set by the restrictor and the terms stored in advance, and determines the suggested terms.

8. The search apparatus according to claim 4, further comprising
a restrictor that sets a restriction on a necessary number of documents for the document list, wherein
the determining unit obtains the relations between terms by using correspondences between the document list obtained by extracting documents that include the search term received by the receiver from among documents that match the restriction set by the restrictor and the terms stored in advance, and determines the suggested terms.

9. The search apparatus according to claim 5, further comprising
a restrictor that sets a restriction on a necessary number of documents for the document list, wherein
the determining unit obtains the relations between terms by using correspondences between the document list obtained by extracting documents that include the search term received by the receiver from among documents that match the restriction set by the restrictor and the terms stored in advance, and determines the suggested terms.

10. The search apparatus according to claim 6, wherein
the restrictor determines the necessary number of documents by using the number of documents and a predetermined number of suggested terms.

11. The search apparatus according to claim 7, wherein
the restrictor determines the necessary number of documents by using the number of documents and a predetermined number of suggested terms.

12. The search apparatus according to claim 8, wherein
the restrictor determines the necessary number of documents by using the number of documents and a predetermined number of suggested terms.

13. The search apparatus according to claim 9, wherein
the restrictor determines the necessary number of documents by using the number of documents and a predetermined number of suggested terms.

14. The search apparatus according to claim 1, wherein
the determining unit determines the suggested terms by using a Jaccard coefficient, a Dice coefficient, or a Simpson coefficient.

15. The search apparatus according to claim 1, wherein
the determining unit determines the suggested terms by using a difference in the number of documents obtained by adding terms to be suggested to a query.

16. The search apparatus according to claim 3, wherein
the determining unit determines the suggested terms by using a dummy term that is virtually determined and with which a search result includes a predetermined ideal number of documents and the search result does not overlap with search results using other terms.

17. The search apparatus according to claim 1, further comprising
a display unit that displays the number of documents for a query before the refined searches, an amount of documents in a case where any of the suggested terms is added to the query, an overlap in a case where any of the suggested terms is added to the query, an imbalance in a case where any of the suggested terms is added to the query, and a loss in a case where any of the suggested terms is added to the query as respective regions.

18. The search apparatus according to claim 17, further comprising
an adding unit that adds, to the query, a term that corresponds to a region selected from among the regions.

19. A search system comprising:
the search apparatus according to claim 1; and
an information processing terminal to which a term to be received by the receiver is input and that displays a determination result obtained by the determining unit.

20. A non-transitory computer readable medium storing a program causing a computer to execute a process for search, the process comprising:
receiving a search term for a search; and
determining suggested terms to be used for refined searches, the refined searches each using the search term and a respective one of the suggested terms, wherein
the suggested terms are determined based on (i) an amount of overlap between results of the refined searches and/or (ii) an amount of difference between the number of results of one of the refined searches and the number of results of another one of the refined searches.
